(19) United States
(12) Patent Application Publication
(10) Pub. No.: US 2026/0318502 A1
(43) Pub. Date: Oct. 15, 2026

(54) SIDE LIGHT-EMITTING APPARATUS AND LIGHTING FIXTURE

(71) Applicants: OPPLE LIGHTING CO., LTD., Shanghai (CN); SUZHOU OPPLE LIGHTING CO., LTD., Suzhou City (CN)

(72) Inventors: Chaobo LIU, Shanghai (CN); Haisheng LIU, Shanghai (CN); Haiqiang HU, Shanghai (CN); Xiaotong YANG, Shanghai (CN); Zheng LIU, Shanghai (CN)

(73) Assignees: OPPLE LIGHTING CO., LTD., Shanghai (CN); SUZHOU OPPLE LIGHTING CO., LTD., Suzhou City (CN)

(21) Appl. No.: 19/686,996

(22) Filed: May 25, 2026

Related U.S. Application Data
(63) Continuation of application No. PCT/CN2024/133850, filed on Nov. 22, 2024.

(30) Foreign Application Priority Data
Nov. 23, 2023 (CN) 202311578433.0
Nov. 23, 2023 (CN) 202323178494.6

(51) Int. Cl. F21V 7/00; F21S 8/00; F21V 5/02; F21V 7/04; F21V 15/01; F21Y 105/18; F21Y 113/13; F21Y 115/10

(52) U.S. Cl. CPC F21V 7/0008; F21S 8/006; F21V 5/02; F21V 7/0066; F21V 7/041; F21V 15/01; F21V 2200/20; F21Y 2105/18; F21Y 2113/13; F21Y 2115/10

(57) ABSTRACT

A side light-emitting device includes a frame, a light source module disposed inside the frame, and a light distribution member disposed on a light exiting path of the light source module. The light source module emits light in a direction parallel to an extending direction of the frame, and the light distribution member redirects the light to be emitted away from the frame. The side light-emitting device may further include a light outlet member defining a light emitting area, a non-light-emitting area, and a light-shadow transition area. A lamp including the side light-emitting device and a surface light-emitting device surrounded by the side light-emitting device is also provided. The side light-emitting device is configured to provide controlled side illumination and improve lighting uniformity and visual effects.

### CROSS-REFERENCE TO RELATED DISCLOSURES

This disclosure is based upon and claims the priority of PCT patent disclosure No. PCT/CN2024/133850 filed on Nov. 22, 2024, which claims priority to the Chinese patent disclosure No. 202311578433.0 filed on Nov. 23, 2023 and the Chinese patent disclosure No. 202323178494.6 filed on Nov. 23, 2023, the entire contents of which are hereby incorporated by reference herein for all purposes.

### TECHNICAL FIELD

The present disclosure relates to the field of lighting, and in particular, to a side light emitting device and a lamp.

### BACKGROUND

With the improvement of living standards, people have increasingly higher requirements for lighting in various scenarios. Lamps capable of simulating outdoor natural ambient light have gained growing market popularity and are widely applied to indoor lighting for residences, office buildings, shopping malls, stadiums, stations, airports and other places.

### SUMMARY

The present disclosure provides a side light-emitting device and a lamp incorporating the side light-emitting device.

According to one aspect, a side light-emitting device is provided and may include a frame, a light source module disposed within the frame, and a light distribution member arranged on a light exiting path of the light source module. The light source module emits light substantially parallel to an extending direction of the frame, and the light distribution member redirects the light to be emitted away from the frame.

In some examples, the side light-emitting device further includes a light outlet member defining a light emitting area, a non-light-emitting area, and a light-shadow transition area, thereby providing a controlled lighting distribution. The light distribution member may cooperate with a reflection member, prism sheet, lens, reflector cup, or other optical structures to direct and shape emitted light.

According to another aspect, a lamp is provided and may include the side light-emitting device and a surface light-emitting device surrounded by the side light-emitting device. The side light-emitting device may enable efficient side illumination, improved light uniformity, and enhanced visual lighting effects.

It is to be understood that both the foregoing general description and the following detailed description are exemplary and explanatory only and are not restrictive of the present disclosure.

### BRIEF DESCRIPTION OF DRAWINGS

FIG. 1 is a stereoscopic structural view of a lamp according to an example of the present disclosure.

FIG. 2 is a sectional view of the lamp shown in FIG. 1.

FIG. 3 is an exploded structural view of the lamp shown in FIG. 1.

FIG. 4 is a planar schematic view of a first light emitting module in the lamp shown in FIG. 3.

FIG. 5 is a schematic view of a light emitting module in the first light emitting module shown in FIG. 3.

FIG. 6 is a schematic view of a light source module in the lamp shown in FIG. 3.

FIG. 7 is an exploded structural view of Example 2 of the side light emitting device of the present disclosure.

FIG. 8 is a schematic view of a light source module in FIG. 7.

FIG. 9 is an exploded structural view of a light distribution member of Example 3 of the side light emitting device of the present disclosure.

FIG. 10 is an optical path diagram in the case where the light distribution member is a lens.

FIG. 11 is an optical path diagram in the case where the light distribution member is an eccentric lens.

FIG. 12 is an optical path diagram in the case where the light distribution member is a reflector cup.

FIG. 13 is an optical path diagram in the case where the light distribution member is an eccentric reflector cup.

FIG. 14 is a stereoscopic structural view of a projection device according to an example of the present disclosure.

FIG. 15 is an exploded structural view of the projection device shown in FIG. 14.

FIG. 16 is an illumination effect diagram of the lamp according to an example of the present disclosure.

FIG. 17 is an illumination effect diagram of the surface light emitting device and the side light emitting device of the lamp according to an example of the present disclosure.

### DETAILED DESCRIPTION

To make the objectives, technical solutions and advantages of the present disclosure clearer, the present disclosure will be described in detail below with reference to the accompanying drawings and examples.

It should be noted that to avoid obscuring the present disclosure due to unnecessary details, the accompanying drawings only show structures and/or processing steps closely related to the solutions of the present disclosure, while other details irrelevant thereto are omitted.

Furthermore, the terms “comprise”, “include” and any variations thereof are intended to cover non-exclusive inclusion. Accordingly, a process, method, article or device comprising a set of elements shall encompass not only those elements, but also other unlisted elements or elements inherent to the process, method, article or device.

Reference Numerals used in this disclosure may include:
100—Lamp
200—Surface light emitting device, 201—Light-exiting surface, 210—First light emitting module, 211—First substrate, 212—Light emitting module, 2121—First light emitting unit, 2122—Second light emitting unit, 220—Diffusion structure, 240—Transparent plate, 250—Inner frame
300—Side light emitting device, 301—Light emitting area, 302—Non-light emitting area, 303—Virtual image, 304—Light-shadow transition area, 310—Light source module, 311—Light source substrate, 312—Light emitting member, 320—Light guide assembly, 321—Light outlet member, 322—Light distribution member, 3221—Fine structure, 323—Reflection member, 324—Light shielding member, 325—Light guide lens, 326—Prism sheet
400—Projection system, 4101—Projection device, 420—Light emitting assembly, 421—Aluminum substrate, 422—Lamp bead, 430—Lens assembly, 431—First lens, 432—Second lens, 433—Third lens, 451—First lens barrel, 452—Second lens barrel, 453—Third lens barrel, 440—Diaphragm
500—Mounting system
600—Housing, 610—Bottom wall, 620—Frame

A sky lamp may generally consist of a light source and a pattern plate printed with blue sky and white cloud patterns, and the pattern plate is illuminated by light source to create an outdoor blue sky lighting atmosphere. Nevertheless, such scheme fails to restore the matching effect between blue sky and sunlight, featuring poor hierarchical sense, insufficient stereoscopic perception and low simulation fidelity.

In response to the problem, sky lamps adopting a light source combined with a scattering panel have emerged on the market to generate light similar to natural sunlight. When real sunlight penetrates indoors through windows, it illuminates one edge of the window.

In view of the above, it is essential to develop a side light emitting device and a lamp which can simulate the effect of sunlight illuminating one edge of a window.

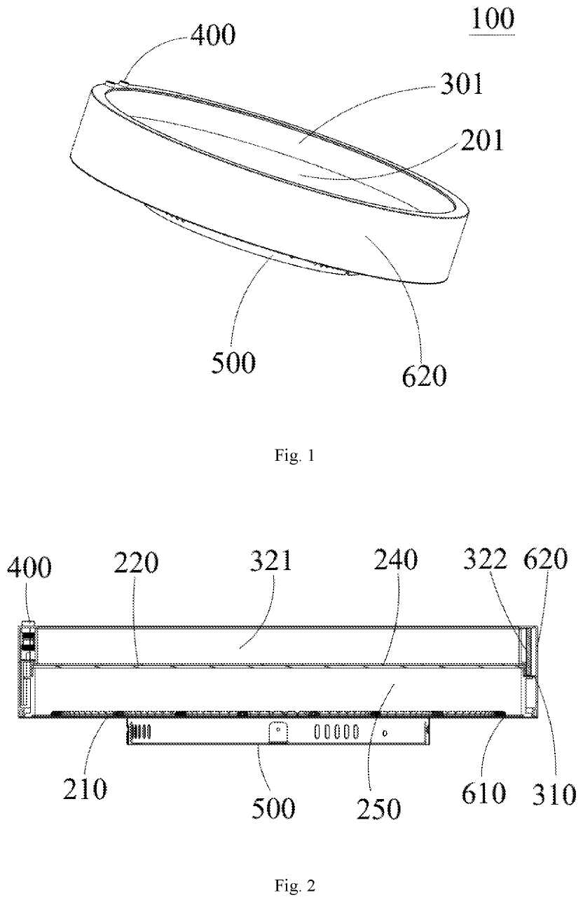

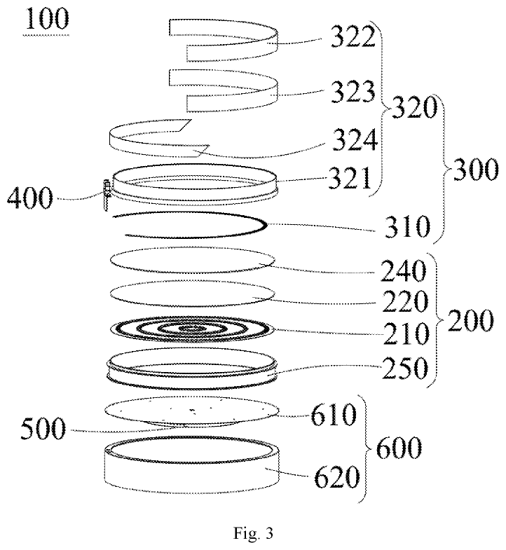

Referring to FIGS. 1 to 3, a lamp 100 according to an example of the present disclosure includes a surface light emitting device 200, a side light emitting device 300 and a projection system 400. The surface light emitting device 200 is configured to simulate sunlight at different times in nature, the side light emitting device 300 is arranged around the outer side of the surface light emitting device 200 and is configured to simulate the effect of sunlight irradiating the edge of the skylight. In addition, the side light emitting device 300 can form a virtual image 303. The projection system 400 is disposed beside the side light emitting device 300 and configured to form light spots on ground or wall surfaces.

The lamp 100 includes a housing 600, the housing 600 includes a bottom wall 610 and a frame 620 extending from the bottom wall 610 away from the bottom wall 610, and a light outlet is between the bottom wall 610 and the frame 620. The surface light emitting device 200 comprises a first light emitting module 210 and a diffusion structure 220; the first light emitting module 210 is fixedly connected to the bottom wall 610 and is configured to emit light towards the diffusion structure 220; the diffusion structure 220 is mounted inside the frame 620 and covers the first light emitting module 210, and the diffusion structure 220 is configured to homogenizes light emitted by the first light emitting module 210.

In an optional example, the surface light emitting device 200 is a ceiling lamp including a chassis, a face shield and the first light emitting module 210. The first light emitting module 210 adopts full-spectrum LED chips capable of simulating solar spectrum. In other examples, the first light emitting module 210 may adopt conventional white light sources. Nanoparticles are added into the diffusion structure 220 of the surface light emitting device 200 to generate Rayleigh scattering, so that the light exit surface 201 presents sky blue. The present disclosure is not limited thereto.

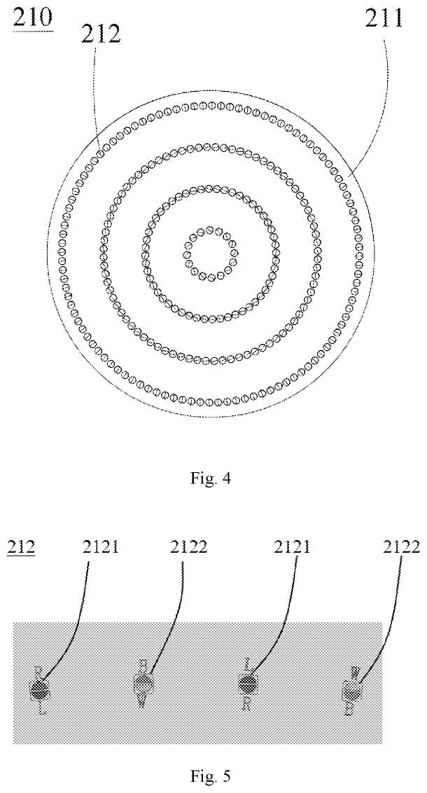

Referring to FIGS. 2 to 5, the surface light emitting device 200 includes the first light emitting module 210 and the diffusion structure 220 in an example. The first light emitting module 210 comprises a first substrate 211 and a plurality of light emitting modules 212. The first substrate 211 is fixed to the bottom wall 610, the light emitting modules 212 are mounted on the side of the first substrate 211 away from the bottom wall 610 and electrically connected through the first substrate 211.

Each light emitting module 212 includes at least two types of light emitting units which can emit light of at least two different spectra. The at least two types of light emitting units are arranged in a staggered manner, and adjacent light emitting units of the same type are reversely disposed.

As shown in FIG. 5, each light emitting module 212 of the first light emitting module 210 includes first light emitting units 2121 and second light emitting units 2122. The two types of units, namely first light emitting units 2121 and second light emitting units 2122, are arranged alternately, and adjacent two first light emitting units 2121 are reversely placed or adjacent two second light emitting units 2122 are reversely placed. The first light emitting unit 2121 includes light emitting members of any two kinds of colors among light emitting members of four different colors, while the second light emitting unit 2122 includes the light emitting members of the remaining two kinds of colors. A single light emitting module is sequentially arranged with the first light emitting unit 2121, the second light emitting unit 2122, the first light emitting unit 2121 and the second light emitting unit 2122. The different types of units, namely the first light emitting units 2121 and the second light emitting units 2122, are distributed alternately, while adjacent first light emitting units 2121 or adjacent second light emitting units 2122 are arranged in reverse distribution. These four types of light emitting members can achieve diverse lighting effects, and alternate arrangement of different types of light emitting units and reverse arrangement of the ones of the same type homogenize the light color emitted by the surface light emitting device 200 better, simulating sunlight hues at different times and achieving dynamic light effects.

Each light emitting module includes two first light emitting units 2121 and two second light emitting units 2122 in this example. The quantities of the first light emitting units 2121 and the second light emitting units 2122 can be increased in other examples, and no restriction is imposed herein.

Light source lenses (not shown) are sleeved on the light emitting units of the light emitting module. In this example, each light emitting unit is correspondingly fitted with a light source lens. That is, the light source lenses are arranged in one-to-one correspondence with the light emitting units. In this way, light emitted by the light emitting units can be concentrated at the center of the light source lenses before being emitted outward and avoid mutual light interference. In other examples, the light source lens may also be two-in-one, four-in-one or other combined lenses, so as to cover more light emitting units with a single lens, alternatively, one single light source lens may cover all the light emitting units, reducing lens quantity and simplifying production and assembly.

In this example, the light emitting units are arranged in a circle on the first substrate 211. Specifically, they are disposed in multiple concentric circles. The number of light emitting units in each circle is a multiple of 6, 7 or 8, which is determined according to the voltage of the light emitting units and the driving power supply. In this example, the voltage of the lamp beads 422 is 3V and the driving voltage is 24V, so an eight-series connection mode is adopted. Namely, the quantity of light emitting units in each concentric circle is a multiple of eight.

In this example, there are Ri circles of light emitting units on the first substrate 211, where i≥2. The number of light emitting units in the R1 circle is N, the number of light emitting units in the R2 circle is 2N, and the number of light emitting units in the Ri circle is i*N. Assume the R1 circle has one string marked as 1_1, the R2 circle has two strings marked as 2_1 and 2_2, and so on, the Ri circle is marked from i_1 to i_i. The total number of strings is i*(i+1)*(i+2)/6, and it is equivalent to adjusting i*(i+1)*(i+2)/6 light beams. Equipped with four types of light emitting members in different colors, the device can regulate color and brightness for 4*i*(i+1)*(i+2)/6 areas. The control system precisely controls the power of light emitting units in each area, achieving continuous light variation from morning to night.

The light emitting units may also be arranged in a square ring shape and other shapes, which shall not be construed as limitations.

The surface light emitting device 200 includes an inner frame 250 and the diffusion structure 220. The inner frame 250 is nested inside the frame 620, and the diffusion structure 220 is fixedly connected to the end of the inner frame 250 away from the first light emitting module 210. Light emitted by the light emitting units in the first light emitting module 210 passes through the diffusion structure, and is scattered by the diffusion structure to convert linear or point light sources into uniform surface light sources. In this example, the diffusion structure 220 is a diffusion plate with transmittance ranging from 40% to 65% and a thickness of approximately 3 mm.

The diffusion plate can effectively eliminate grainy visual effect of light emitted from the first light emitting module 210 and has a function of diffusing light, that is, light can scatter on its surface and radiates softly and evenly. After diffusion, the light covers a larger area with favorable uniformity and stable chromaticity.

In other examples, the diffusion structure 220 may also be a component with fine/micro structures which covers the light emitting module, the component with fine/micro structures can also achieve favorable light homogenization effect. No specific limitation is imposed herein.

In some examples, the surface light emitting device 200 further includes a transparent plate 240. The transparent plate 240 is fixedly connected to the end of the inner frame 250 away from the first light emitting module 210, and disposed on the side of the light-exiting surface 201 facing away from the first light emitting module 210. The side of the transparent plate 240 away from the light-exiting surface 201 is a mirror surface. At least part of the light emitted by the side light emitting device 300 passes through the light outlet area 301 and then projects onto the transparent plate 240, then is reflected by the transparent plate 240 to form a virtual image 303, which simulates the effect of window shadow formed when one side of a window is illuminated by sunlight, bringing a profound and transparent visual perception to human eyes.

The mirror surface of the transparent plate 240 has higher reflectivity than transmittance for light, blocking external light from entering the plate through the light exit surface. Optionally, the transparent plate 240 may be made of inorganic materials such as quartz glass. The transparent plate 240 may also be made of organic materials including polymethyl methacrylate and other polymer transparent materials, with no limitation specified herein.

In some examples, a thin one-way film layer made of tin, silver, aluminum or the like is coated on the light-exiting surface of the transparent plate 240 via crystal plating process. The crystal plating process endows the film layer with high surface smoothness. In other examples, the material of the transparent plate 240 may be selected according to practical demands without restriction. The thickness of the one-way film layer may be adjustable according to practical demands. As the thickness of the one-way film layer increases, its reflectivity and transmittance will change, so that the one-way perspective effect is achieved when the reflectivity is higher than the transmittance.

By adjusting the brightness of light emitting units in different areas, lighting effects of diverse modes such as morning glow and sunset glow can be realized.

The side light emitting device 300 is detachably connected with the lamp 100, the side light emitting device 300 is disposed between the frame 620 and the surface light emitting device 200, and surrounds the light exit surface 201 of the surface light emitting device 200. The side light emitting device 300 extends along the light emitting direction of the first light emitting module 210 and is provided with a light emitting area 301 attached to the side of the frame 620 close to the light-exiting surface 201. The side light emitting device 300 further includes a light source module 310. In a horizontally, the light source module 310 is disposed between the light outlet area 301 and the frame 620. Light emitted by the light source module 310 passes through the light outlet area 301 and then is emitted toward a direction away from the frame 620. Emitted light beams from the light outlet area 301 intersect with those from the light-exiting surface 201, and at the same time, the light outlet area 301 emits light obliquely downward, so as to prevent light from irradiating the non-light emitting area 302 of the side light emitting device 300. Different from conventional ambient lights, the side light emitting device 300 only emits light toward the inner side of the lamp 100. In this example, the frame 620 is made of an opaque material, creating a visual effect of sunlight penetrating in and lighting up the window sill, and forming a visual effect of a light-transmitting window.

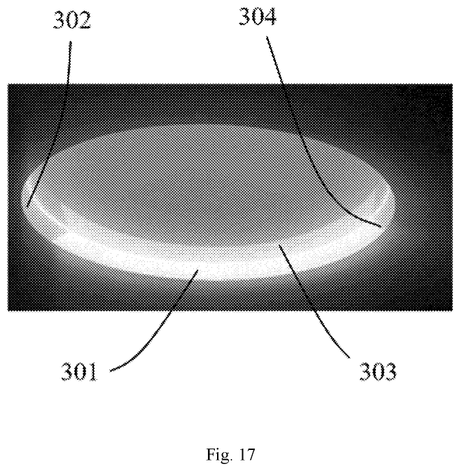

The side light emitting device 300 further comprises a non-light emitting area 302 which is also arranged away from the frame 620. A light-shadow transition area 304 is formed between the non-light emitting area 302 and the light outlet area 301. As shown in FIG. 17, this structure simulates the scene that sunlight injects from one side to illuminate one window sill and form a dark surface on the window sill at the opposite side of the window, achieving a more realistic display effect. The light outlet area 301 and the non-light emitting area 302 are circumferentially connected to jointly form an annular surface on the periphery of the light-exiting surface 201. The light-shadow transition area 304 is located at the junction of the light outlet area 301 and the non-light emitting area 302, the function of the light-shadow transition area 304 is to form a light-dark boundary region between the light outlet area 301 and the non-light emitting area 302, which can be a continuously changing area from bright to dark or a distinct dividing line.

The side light emitting device 300 includes a light source substrate 311 surrounding the light exit surface 201 and a light emitting member 312 arranged on the light source substrate 311. The light source substrate 311 includes an illuminated area arranged close to the light emitting area 301 and a non-illuminated area arranged away from the light emitting area 301, so as to form an illuminated light emitting area 301 and a non-illuminated light emitting area 302 on the outer periphery of the light exit surface 201, the light emitting member 312 is arranged on the illuminated area of the light source substrate 311, and the non-illuminated area may be not provided with the light emitting member 312.

In some examples, the side light emitting device 300 further includes a light shielding member 324 facing away from the light emitting area 301, and the light source module 310 and the light shielding member 324 jointly surround a side of the light exit surface 201 close to the frame 620 to form an illuminated light emitting area 301 and a non-illuminated light emitting area 302 at the outer periphery of the light exit surface 201.

The side light emitting device 300 may be arranged to rotate relative to the surface light emitting device 200 as a whole, and the side light emitting device 300 is driven to rotate by a micro-motor arranged in the lamp 100, so as to better simulate the effect that the sun rises in the east and sets in the west.

The side light emitting device 300 will be described below through three examples, but it should not be limited to this.

### EXAMPLE 1

As shown in FIGS. 2-3 and 6, in this example, the light emitting direction of the light source module 310 is the same as that of the first light emitting module 210, and the side light emitting device 300 includes the light source module 310 and a light guide assembly 320, the light guide assembly 320 includes a light distribution member 322 and a light outlet member 321, and the light distribution member 322 is arranged below the light source module 310. The light source module 310 emits light toward the light distribution member 322 (i.e., the light source module 310 emits light directly), the light distribution member 322 is configured to refract the light emitted from the light source module 310, and the light outlet member 321 is located on the side of the light distribution member 322 away from the frame 620. After being refracted by the light distribution member 322, the light emitted from the light distribution member 322 is emitted toward the side away from the frame 620 through the light outlet member 321. The light distribution part 322 can control the emergent angle of the light, so that the light can be emitted at a small angle, with a long mapping distance and stronger permeability.

In some examples, the end of the light outlet member 321 away from the surface light emitting device 200 is inclined by 5°-30° to the frame 620, so as to make the light emitted from the light emitting region 301 have a wider irradiation range.

In this example, the light distribution member 322 is a light guide plate, and the materials of the light distribution member 322 and the light outlet member 321 are transparent optical materials such as PMMA and PC. In other examples, the light distribution member 322 may also be an optical element of other structures or other materials, which is not limited by the present disclosure.

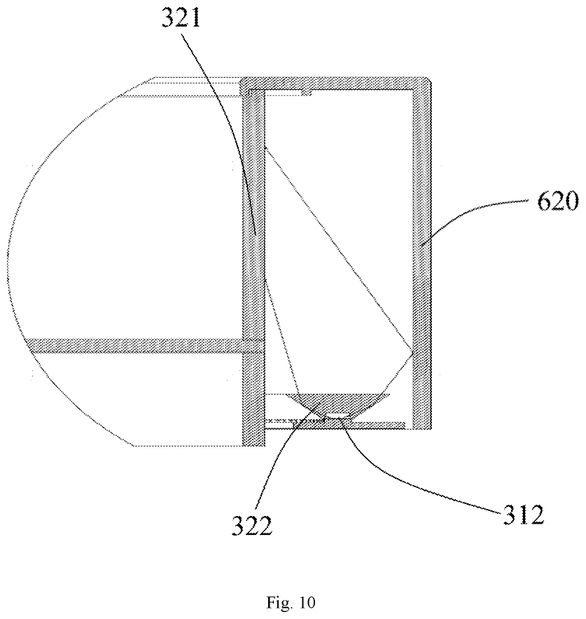

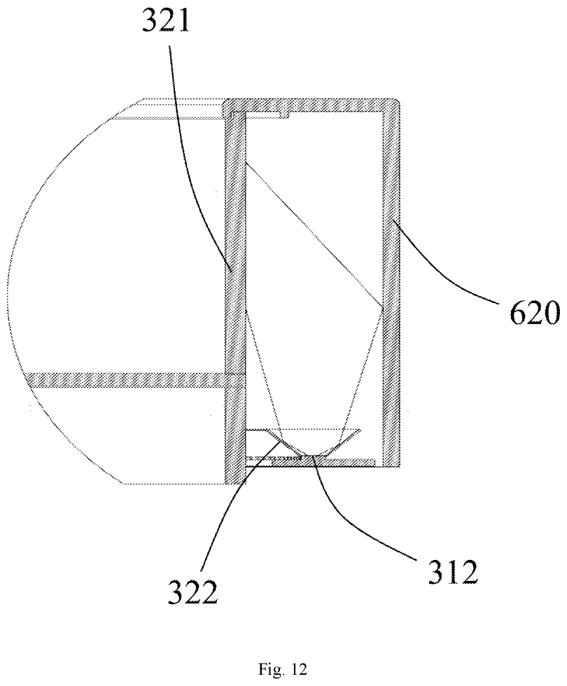

As shown in FIG. 10, in some examples, the light distribution member 322 is a lens, or as shown in FIG. 12, in some examples, the light distribution member 322 is a reflector cup, the lens or the reflector cup is located in the light emitting direction of the light source module 310 and cover the light emitting member 312. After being refracted by the lens or the reflector cup, a part of the light emitted by the light emitting member 312 is emitted toward the light outlet member 321, while the other part of light is emitted toward the frame 620. A reflection member 323 is provided on the side of the frame 620 close to the light outlet member 321 to reflect the light emitted to this part, and the light reflected by the reflector 232 is emitted toward the light outlet member 321.

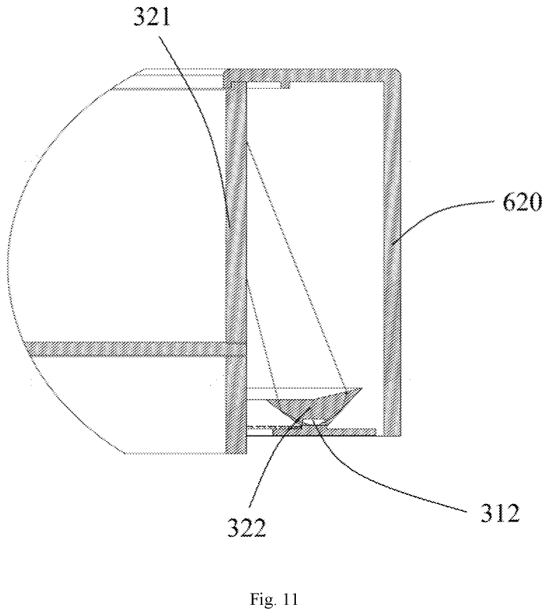

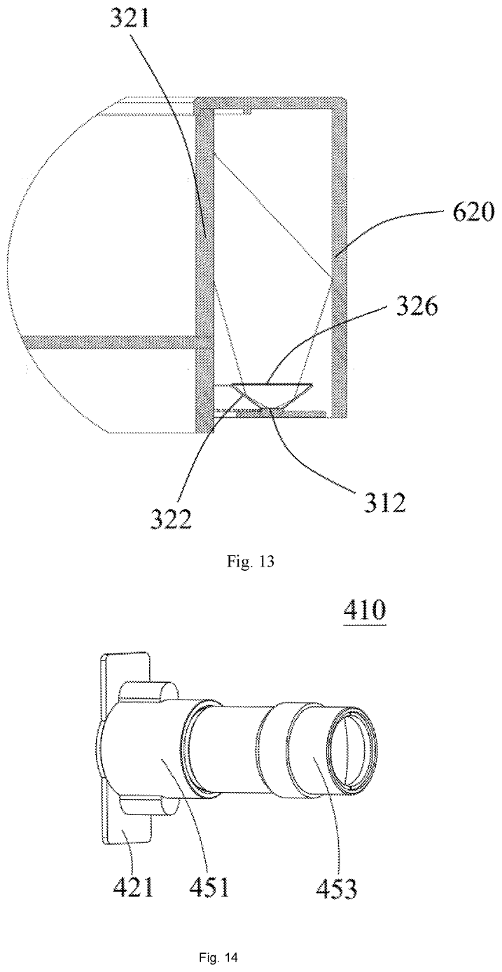

As shown in FIG. 11, in some examples, the light distribution part 322 is an eccentric lens, or as shown in FIG. 13, in some examples, the light distribution part 322 is an eccentric reflector cup, the eccentric lens or the eccentric reflector cup cover the light emitting member 312. After being refracted by the eccentric lens or the eccentric reflector cup, all the light emitted from the light emitting member 312 enters the light outlet member 321 toward the direction away from the frame 620.

As shown in FIG. 12, in some examples, in the case where the light distribution member 322 is a reflector cup, the end of the reflector cup away from the light source module 310 is covered with a prism sheet 326 which is configured to refract a part of light emitted by the light emitting module 310 that is not refracted by the reflector cup, so that the part of light is refracted by the prism sheet and then emitted toward the light outlet member 321 or toward the reflective member 323 on the frame 620, thus improving the utilization rate of the light emitted by the light source module 310.

In some other examples, the light emitted by the light source module 310 may also be vertically upward emitted into the light guide assembly 320, which is not limited by the present disclosure.

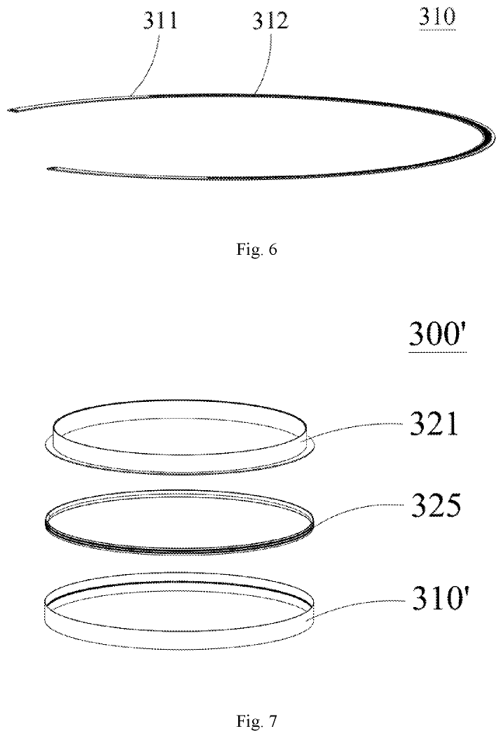

As shown in FIG. 6, the light source module 310 includes a light source substrate 311 and light emitting members 312 installed in a part of area on the light source substrate 311. When the light emitting members 312 on the light source module 310 emit light outward, the area in the light guide assembly 320 corresponding to the light emitting members 312 on the light source substrate 311 is in a bright state (i.e., the light emitting area 301 of the side light emitting device 300), and the area of the light guide assembly 320 that does not correspond to the light emitting member 312 on the light source substrate 311 is in a dark state (i.e., the non-light emitting area 302 of the side light emitting device 300), so as to simulate the effect of illuminating the edge of one side of the window when sunlight shines into the room through the window.

In other examples, all areas on the light source substrate 311 may be equipped with light emitting members 312. By controlling the working state of the light emitting members 312 in different areas, the light source can be changed by lighting different positions, so that the conversion between bright areas and dark areas on the light emitting members can be realized, and the effect of sunlight shining on the edge of the skylight at different angles in different time periods in a day can be simulated, and the sunrise and sunset can be realized. In this example, the frame 620 is made of translucent or translucent material. By controlling the different light emitting colors of the light emitting members 312 in different areas, a rainbow effect can be formed through the frame 620, and the visual experience of the lamp 100 can be improved.

The light emitted after passing through the light distribution part 322 will pass through the light outlet member 321, which can eliminate the graininess of the light emitted by the light source module 310, and at the same time, the light emitted after passing through the light outlet member 321 will be more uniform.

A reflection member 323 is attached to the side of the light distribution member 322 away from the light outlet member 321 or to the side of the frame 620 close to the light outlet member 321, so as to reflect the light emitted to the area where the reflection member 323 is located back, so that the light is emitted in the direction toward the light outlet member 321, and the light concentration is improved.

The part of the light outlet member 321 that is not covered by the light distribution part 322 is covered with the light shielding member 324. By setting the light shielding member 324 here, light can be prevented from leaking out of this part of the light outlet member 321, so as to ensure that this part of the light outlet member 321 is in a dark state and simulate the effect of real sunlight shining on the edge of a window or skylight.

In some other examples, the light shielding member 324 may rotate around the light distribution member 322. In the case where all the areas on the light source substrate 311 are equipped with the light emitting members 312, the change of bright areas and dark areas on the light outlet members 321 can be realized by rotating the light shielding member 324.

The height of the light shielding member 324 can be adjusted according to the actual situation, and the adjustment can be made through the elastic member provided by the micro motor.

### EXAMPLE 2

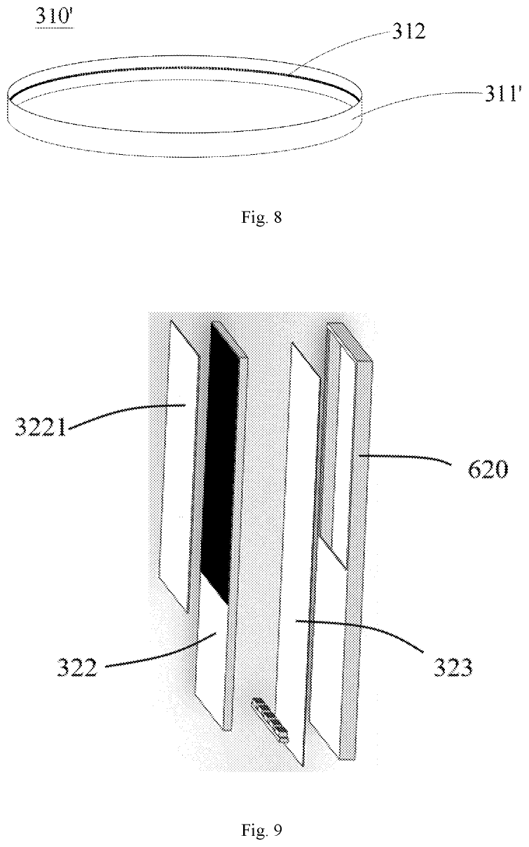

As shown in FIGS. 7-8, in this example, the light emitting direction of the light source module 310′ intersects with that of the first light emitting module 210, and the side light emitting device 300 includes a light outlet member 321 which is arranged between the frame 620 and the light-exiting surface 201 and exceeds the light-exiting surface 201 along the extending direction of the frame 620, and the light source module 310′ is arranged at the light outlet member 321 facing the frame 620. The light source module 310′ includes a ring-shaped light source substrate 311′ and a light emitting member 312 installed inside the substrate. The light source module 310′ emits light toward the light outlet member 321, and the emitted light directly enters the light outlet member 321 from the side surface of the light outlet member 321.

The side light emitting device 300′ further comprises a light guide lens 325, the light guide lens 325 is located between the light outlet member 321 and the light source module 310′, and is connected with the inside of the light source substrate 311′ and covers the light emitting member 312. The light emitted by the light emitting member 312 enters the light incident surface of the light guide lens 325, is refracted at the light incident surface of the light guide lens 325, enters the light guide lens 325 under the condition of satisfying Snell's law, is refracted at the light emergent surface, and then exits the light guide lens 325 and then passes through the light outlet member 321 to realize uniform light emission.

In this example, the light source substrate 311′ may be made of flexible printed circuit board FPC, and in other examples, the light source substrate 311′ may also be made of other materials.

Preferably, the material of the light outlet member 321 is a transparent optical material such as PMMA and PC.

In other examples, all areas on the light source substrate 311′ are provided with light emitting members 312, and the light source substrate 311′ may be divided into a plurality of light emitting areas, each light emitting area includes a plurality of light emitting members 312, and the lighting of each light emitting area can be controlled independently. By controlling the working conditions of different light emitting areas, the conversion between the bright area and the dark area on the light-emitting member 321 can be realized, and the sunlight can be simulated at different time periods in a day.

In some other examples, when all the areas on the light source substrate 311′ are provided with the light emitting members 312, the light shielding elements 324 may also be attached to a part of areas on the light outlet members 321 to prevent the light from leaking out of the parts on the light outlet members 321, so that the parts on the light outlet members 321 are in a dark state, simulating the effect of real sunlight shining on the edge of a window or skylight. The shading plate may rotate, and the change of bright light area on the light outlet member 321 can be realized by rotating the light shielding member 324, so as to simulate the effect of sunrise and sunset.

In this example, the overall structure of the side light emitting device 300 is more simplified, and the light source module 310′ surrounds the outside of the light outlet member 321, so that the assembly is more convenient and quick.

### EXAMPLE 3

In this example, the structure of the side light emitting device 300 is basically the same as that of the first example. The side light emitting device 300 emits light only to the side away from the frame 620. The light guide assembly 320 includes a light outlet member 321 and a light distribution part 322. The light source module 310 is fixedly connected with one end of the light outlet member 321, and the light distribution part 322 is arranged around the outside of the light outlet member 321. The upper end face of the light distribution member 322 covers the light emitting member 312 on the light source module 310, but the difference is that the light emitting area 301 is provided with a fine structure 3221, and the fine structure 3221 is configure that the light is emitted from the area with the fine structure 3221 in the light emitting area 301 at a large angle.

As shown in FIG. 9, the light distribution member 322 in this example is a light guide plate, and the fine structure 3221 is arranged on the light guide plate, is located in the area of the light distribution member 322 away from the light source module 310, and the light outlet member 321 is provided with an inverted fine structure. After the light is emitted from the light emitting member 312, its total reflection is destroyed by the fine structure 3221 on the light distribution member 322, so that the light is emitted from the area where the fine structure 3221 is arranged on the light distribution member 322 at a large angle, and the light emitted from the light distribution member 322 enters the light outlet member 321 with the inverted fine structure. By using the inverted fine structure 3221, part of the light can be emitted to the transparent plate 240 at a small angle and is reflected by the transparent plate 24 to form a transparent virtual image 303.

The angles of the backlight surface and the light-facing surface of the fine structure 3221 on the light distribution member 322 are both less than 6 degrees, and at the same time, the angles change with the distance between the light emitting member 312 and the light incident side of the light distribution member 322, and the depth of the V-groove also changes. For the light-facing surface less than 6 degrees, after the light enters from the light-entering side, the angle of the light coming out from the light-exiting surface is 165 degrees to 175 degrees, and the fine structure 3221 on the light-exiting side compresses the light to within 30 degrees toward the center. The light from 165 degrees to 175 degrees can be emitted at a small angle, and can be emitted at an angle less than 10 degrees, through the inverted V-prism on the light outlet member 321. By adjusting the angle between the light-facing surface and the backlight surface and the depth of the V-groove, the uniformity of the light-exiting surface of the light distribution member 322 can be adjusted.

Preferably, the angles of the backlight surface and the light-facing surface of the V-prism in the light distribution part 322 are both from 0.25 degrees to 0.75 degrees, and the vertex angle of the inverted V-prism in the light outlet member 321 from 55 degrees to 70 degrees.

A reflection member 323 is covered on the side of the light distribution member 322 away from the light outlet member 321, to reflect the light emitted to this area inside the light distribution member 322, so that all the light in the light distribution member 322 are emitted toward the light outlet member 321.

The lamp 100 further includes a projection system 400, the projection system 400 is arranged between the frame 620 and the side light emitting device 300 and at least partially exposed to the frame 620. The projection system 400 is configured to project a sun-like light spot, including a circular light spot, an oval light spot or a quadrilateral light spot, on the wall or the ground, similar to the projection generated by sunlight passing through a window.

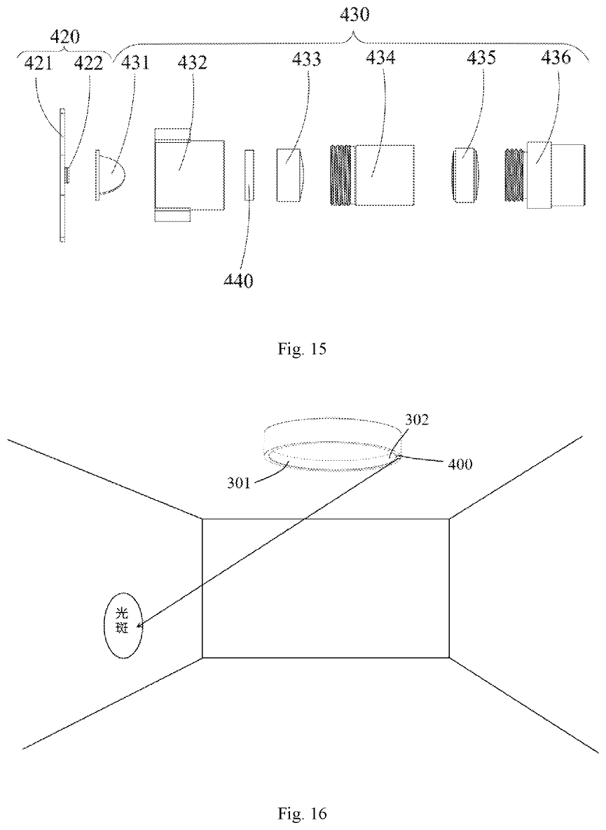

The projection system 400 includes a plurality of projection devices 410. In this example, there are two projection devices 410 which are respectively movably connected with the frame 620 of the lamp 100 through connectors, and the projection devices 410 can rotate relative to the frame 620. As shown in FIGS. 14-15, the projection device 410 includes a light emitting assembly 420, a lens barrel assembly 450 and a lens assembly 430. The light emitting assembly 420 includes an aluminum substrate 421 and a lamp bead 422 mounted on the aluminum substrate 421. The lamp bead 422 is covered with a diaphragm 440, the diaphragm 440 abuts against the aluminum substrate 421 and is configured to control the intensity and shape of the light beam emitted by the lamp bead 422. A first lens 431 is connected to one end of the diaphragm 440 away from the lamp bead 422, and the first lens 431 is configured to form a light spot. A first lens barrel 451 is sleeved outside the diaphragm 440 and the first lens 431, and the second lens barrel 452 is screwed with one end of the first lens barrel 451 away from the first lens 431, and a second lens 432 is embedded in one side of the second lens barrel 452 close to the first lens barrel 451. The end of the second lens barrel 452 away from the first lens barrel 451 is screwed with the third lens barrel 453, and the end of the third lens barrel 453 away from the second lens barrel 452 is embedded with a third lens 433, the second lens 432 and the third lens 433 are configured to perform imaging, and the focal length is adjusted by the first lens barrel 451, the second lens barrel 452 and the third lens barrel 453.

The first lens 431 and the second lens 432 are plastic lenses, and the third lens 433 is glass lens. The plastic lens is lighter, which is beneficial to the lightweight of the whole structure, while the glass lens can ensure higher light transmittance.

In this example, the lamp beads 422 are LED lamp beads, and in other examples, the lamp beads 422 can also be other types of lamp beads, which is not limited by the present disclosure.

As shown in FIG. 16, the projection direction of the projection system 400 is consistent with the direction of the light emitting area 301, and a light spot is projected on the wall at one side of this part of area to simulate the projection of the real sunlight direction on the wall through the window.

The lamp 100 further includes a control system, and the operation of the surface light emitting device 200, the side light emitting device 300 and the projection system 400 is controlled by the control system, so as to realize the lighting effects of various scenes.

The mounting system 500 includes a mounting bracket, the mounting bracket is fixedly connected with the bottom wall 610, and the lamp 100 is fixedly connected with the mounting surface through the mounting bracket. In this example, the installation system 500 is a rack structure, and in other examples, it may also be a quick-connect structure, which is not limited by the present disclosure.

To sum up, the surface light emitting device 200 in the lamp 100 of the present disclosure can simulate the effects similar to blue sky, sunset, morning light and blue sky and white clouds, while the side light emitting device 300 simulates the effect of sunlight shining on the edge of the window, making the lighting effect of the lamp 100 more realistic. The side light emitting device 300 can also form a virtual image 303 on the transparent plate 240, which produces a window shadow effect similar to sunlight shining on the edge of a window or skylight, thus forming a sense of space, depth and layering. The projection system 400 can provide a light spot similar to sunlight projected onto the ground or wall through the window or skylight, and the shape of the light spot changes according to the overall shape of the lamp 100, thus realizing multi-scene application.

The present disclosure aims to provide a side light emitting device capable of simulating the effect of sunlight illuminating one edge of a window.

To achieve the above objective, the present disclosure provides a side light emitting device applied to a lamp, the side light emitting device includes a frame extending in a vertical direction and a light source module arranged inside the frame, the light source module emits light parallel to an extending direction of the frame, a light distribution member is disposed on a light exiting path of the light source module, and the light is emitted toward a direction away from the frame after being refracted by the light distribution member.

As a further improvement of the present disclosure, the side light emitting device further comprises a light outlet member, the light outlet member is arranged on a side of the light distribution member away from the frame and abuts against the frame, and light emitted by the light source module is emitted passes through the light distribution member and the light outlet member sequentially before exiting, forming a light emitting area on the light outlet member.

As a further improvement of the present disclosure, the side light emitting device further comprises a non-light emitting area disposed away from the frame and adjacent to the light emitting area, and a light-shadow transition area is between the non-light emitting area and the light emitting area.

As a further improvement of the present disclosure, the light source module (310) comprises a light source substrate (311) and a light emitting member (312) arranged on the light source substrate (311), the light emitting member (312) comprises an illuminated area close to the light emitting area (301) and an non-illuminated area away from the light emitting area (301), so as to form the light emitting area (301) which is illuminated and the non-light emitting area (302) which is unilluminated, or, the light emitting member (312) is arranged on a part of region of the light source substrate (311), the light emitting member (312) is configured to form the light emitting area on the light outlet member (321), and a region without light emitting members (312) on the light source substrate (311) forms the non-light emitting area (302), or, the side light emitting device further comprises a light shielding member (324) arranged inside the frame (620) and away from the light emitting area (301), the light distribution member (322) and the light shielding member (324) jointly surround a periphery of the light outlet member (321) to form the light emitting area (301) which is illuminated and the non-light emitting area (302) which is unilluminated.

As a further improvement of the present disclosure, the light distribution member (322) is arranged on the light exiting path of the light source module (310), and the light emitted by the light source module (310) is emitted toward the light outlet member (321) and the frame (620) after being refracted by the light distribution member.

As a further improvement of the present disclosure, the side light emitting device (300) further comprises a reflection member (323), the reflection member (323) is arranged on a side of the frame (620) facing the light outlet member (321), light that is emitted toward the frame (620) after being refracted by the light distribution member (322) enters the reflection member (323) and is emitted toward the light outlet member (321) after being reflected by the reflection member.

As a further improvement of the present disclosure, the light distribution member (322) is one selected from a group consisting of a light guide plate, a lens and a reflector cup.

As a further improvement of the present disclosure, the light distribution member (322) is the reflector cup, a prism sheet covers an end of the reflector cup away from the light source module (310), the prism sheet is configured to refract light emitted from the light source module (310), light after being refracted by the prism sheet is emitted toward the frame (620) and the light outlet member (321).

As a further improvement of the present disclosure, the light distribution member (322) is arranged on the light exiting path of the light source module (310), and the light emitted by the light source module (310) is all emitted toward the light outlet member (321) after being refracted by the light distribution member.

As a further improvement of the present disclosure, the light distribution member (322) is an eccentric lens or an eccentric reflector cup.

As a further improvement of the present disclosure, a fine structure (3221) is arranged in the light emitting area (301), and the fine structure (3221) is configured to adjust a light emission direction.

As a further improvement of the present disclosure, an emission angle of light passing through the fine structure (3221) is less than 10 degrees.

Another objective of the present disclosure is to provide a lamp comprising the aforementioned side light emitting device.

To achieve the above objective, the present disclosure provides a lamp including the aforementioned side light emitting device and a surface light emitting device. The surface light emitting device is configured to emit light outward, and the side light emitting device surrounds the surface light emitting device.

As a further improvement of the present disclosure, the side light emitting device comprises the frame extending in the vertical direction (620), the light source module (310) and a light outlet member (321) that are arranged inside the frame (620), an end of the light outlet member (321) away from the surface light emitting device (200) inclines toward the frame (620).

Compared with other implementations, the technical solution of the present disclosure has the following beneficial effects. According to the side light emitting device provided by the present disclosure, the light source module emits light parallel to the extending direction of the frame, the light distribution member is utilized to guide light emitted by the light source module to be emitted toward a direction away from the frame after being refracted by the light distribution member, to form the light emitting area, so that the structure can simulate the effect of sunlight shining on one side of the window, improving user viewing experience.

The present disclosure may include dedicated hardware implementations such as disclosure specific integrated circuits, programmable logic arrays and other hardware devices. The hardware implementations can be constructed to implement one or more of the methods described herein. Examples that may include the apparatus and systems of various implementations can broadly include a variety of electronic and computing systems. One or more examples described herein may implement functions using two or more specific interconnected hardware modules or devices with related control and data signals that can be communicated between and through the modules, or as portions of an disclosure-specific integrated circuit. Accordingly, the system disclosed may encompass software, firmware, and hardware implementations. The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. The module refers herein may include one or more circuit with or without stored code or instructions. The module or circuit may include one or more components that are connected.

The above examples are only used to illustrate the technical scheme of the disclosure, but not to limit it. Although the disclosure has been described in detail with reference to the examples, those skilled in the art should understand that the technical scheme of the disclosure can be modified or replaced by equivalents without departing from the spirit and scope of the technical scheme of the disclosure.

1. A side light emitting device applied to a lamp, comprising a frame extending in a vertical direction and a light source module arranged inside the frame, wherein the light source module emits light parallel to an extending direction of the frame, a light distribution member is disposed on a light exiting path of the light source module, and the light is emitted toward a direction away from the frame after being refracted by the light distribution member.

2. The side light emitting device according to claim 1, further comprising a light outlet member, wherein the light outlet member is arranged on a side of the light distribution member away from the frame and abuts against the frame, and light emitted by the light source module passes through the light distribution member and the light outlet member sequentially before exiting, forming a light emitting area on the light outlet member.

3. The side light emitting device according to claim 2, wherein the side light emitting device further comprises a non-light emitting area disposed away from the frame and adjacent to the light emitting area, and a light-shadow transition area is between the non-light emitting area and the light emitting area.

4. The side light emitting device according to claim 3, wherein the light source module comprises a light source substrate and a light emitting member arranged on the light source substrate, wherein:
the light emitting member comprises an illuminated area close to the light emitting area and a non-illuminated area away from the light emitting area, so as to form the light emitting area which is illuminated and the non-light emitting area which is unilluminated,
or, the light emitting member is arranged on a part of region of the light source substrate, the light emitting member is configured to form the light emitting area on the light outlet member, and a region without light emitting members on the light source substrate forms the non-light emitting area,
or, the side light emitting device further comprises a light shielding member arranged inside the frame and away from the light emitting area, the light distribution member and the light shielding member jointly surround a periphery of the light outlet member to form the light emitting area which is illuminated and the non-light emitting area which is unilluminated.

5. The side light emitting device according to claim 2, wherein the light distribution member is arranged on the light exiting path of the light source module, and the light emitted by the light source module is emitted toward the light outlet member and the frame after being refracted by the light distribution member.

6. The side light emitting device according to claim 5, wherein the side light emitting device further comprises a reflection member, the reflection member is arranged on a side of the frame facing the light outlet member, light that is emitted toward the frame after being refracted by the light distribution member enters the reflection member and is emitted toward the light outlet member after being reflected by the reflection member.

7. The side light emitting device according to claim 6, wherein the light distribution member is selected from the group consisting of a light guide plate, a lens and a reflector cup.

8. The side light emitting device according to claim 7, wherein the light distribution member is the reflector cup, a prism sheet covers an end of the reflector cup away from the light source module, the prism sheet is configured to refract light emitted from the light source module, light after being refracted by the prism sheet is emitted toward the frame and the light outlet member.

9. The side light emitting device according to claim 2, wherein the light distribution member is arranged on the light exiting path of the light source module, and the light emitted by the light source module is all emitted toward the light outlet member after being refracted by the light distribution member.

10. The side light emitting device according to claim 9, wherein the light distribution member is an eccentric lens or an eccentric reflector cup.

11. The side light emitting device according to claim 2, wherein a fine structure is arranged in the light emitting area, and the fine structure is configured to adjust a light emission direction.

12. The side light emitting device according to claim 11, wherein an emission angle of light passing through the fine structure is less than 10 degrees.

13. A lamp, comprising:
a side light emitting device, wherein the side light emitting device comprises a frame extending in a vertical direction and a light source module arranged inside the frame, the light source module emits light parallel to an extending direction of the frame, a light distribution member is disposed on a light exiting path of the light source module, and the light is emitted toward a direction away from the frame after being refracted by the light distribution member; and
a surface light emitting device, wherein the surface light emitting device emits light outward, and the side light emitting device surrounds the surface light emitting device.

14. The lamp according to claim 13, wherein the side light emitting device comprises the frame extending in the vertical direction, the light source module and a light outlet member that are arranged inside the frame, an end of the light outlet member away from the surface light emitting device is inclined toward the frame.
